(19) United States
(12) Patent Application Publication
(10) Pub. No.: US 2003/0023887 A1
(43) Pub. Date: Jan. 30, 2003

(54) Computer system with backup management for handling embedded processor failure

(76) Inventors: David R. Maciorowski, Parker, CO (US); Michael John Erickson, Loveland, CO (US); Paul J. Mantey, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/918,027

(22) Filed: Jul. 30, 2001

(51) Int. Cl. G06F 1/26; G06F 1/28; G06F 1/30

(52) U.S. Cl. 713/300

(57) ABSTRACT

A system for providing basic system control functions upon failure of a management processor in a computer system. During normal system operation, a management processor monitors system sensors that detect system power, temperature, and cooling fan status, and make necessary adjustments. The management processor normally provides an output signal indicating that it is operating properly. A high-availability controller monitors each of these signals to verify that there is at least one operating management processor. When none of the processors indicate that they are operating properly, the high-availability controller monitors the system sensors and updates system indicators. If a problem develops, such as failure of a power supply or a potentially dangerous increase in temperature, the high-availability controller sequentially powers down the appropriate equipment to protect the system from damage.

### FIELD OF THE INVENTION

The present invention relates generally to computer systems, and more particularly, to a system comprising a backup management processor that provides basic system control functions upon failure of one or more system management processors.

### BACKGROUND OF THE INVENTION

### Statement of the Problem

Certain existing computer systems include a management processor to monitor and control aspects of the system environment such as power, power sequencing, temperature, and to update panel indicators. Failure of the management processor may result in system failure due to the inability to monitor and control system status, power, temperature, and the like.

Even in systems having a peer or backup management processor, however, a firmware bug common to all management processors can cause the system processor to effectively become non-operational, since all of these processors are typically programmed with essentially the same code, and thus all of them are likely to succumb to the same problem when a faulty code sequence is executed.

### Solution to the Problem

The present system solves the above problems and achieves an advance on the field by providing a high-availability controller that monitors the status of the management processor. If the management processor should fail, the controller provides at least a minimal set of functions required to allow the system to continue to operate reliably. Furthermore, the high-availability controller does not perform the same sequence of operations as the code executed by the management processor, and therefore is not susceptible to failure resulting from a specific ‘bug’ that may cause the management processor to fail.

The present system includes a power management subsystem that controls power to all system entities and provides protection for system hardware from power and environmental faults. The power management subsystem also controls front panel LEDs and provides bulk power on/off control via a power switch.

During normal system operation, the management processor monitors system sensors that detect system power, temperature, and cooling fan status, and makes necessary adjustments or reports problems. The management processor also updates various indicators and monitors user-initiated events such as turning power on or off.

The management processor normally provides an output signal indicating that it is operating properly. The high-availability controller monitors this signal to verify that the management processor is operating. When the management processor indicates that it is not operating properly, the high-availability controller monitors the system sensors and updates system indicators. If a problem develops, such as failure of a power supply or a potentially dangerous increase in temperature, the high-availability controller powers down the appropriate equipment to protect the system from damage. In addition, if a system user decides to power down the system, the high-availability controller is responsive to the power switch, which can be used to initiate powering down of the system when the management processor has failed.

### BRIEF DESCRIPTION OF THE DRAWINGS

FIG. 1 is a block diagram illustrating basic components of the present system;

FIG. 2 is a block diagram illustrating exemplary components utilized in one embodiment of the present system;

FIG. 3 is a flowchart showing an exemplary sequence of steps performed by the high-availability controller in accordance with the present system;

FIG. 4 is a block diagram illustrating, in greater detail, components of the high-availability controller of the present system; and

FIG. 5 is a flowchart showing an exemplary sequence of steps performed by the high-availability controller operation state machine.

### DETAILED DESCRIPTION

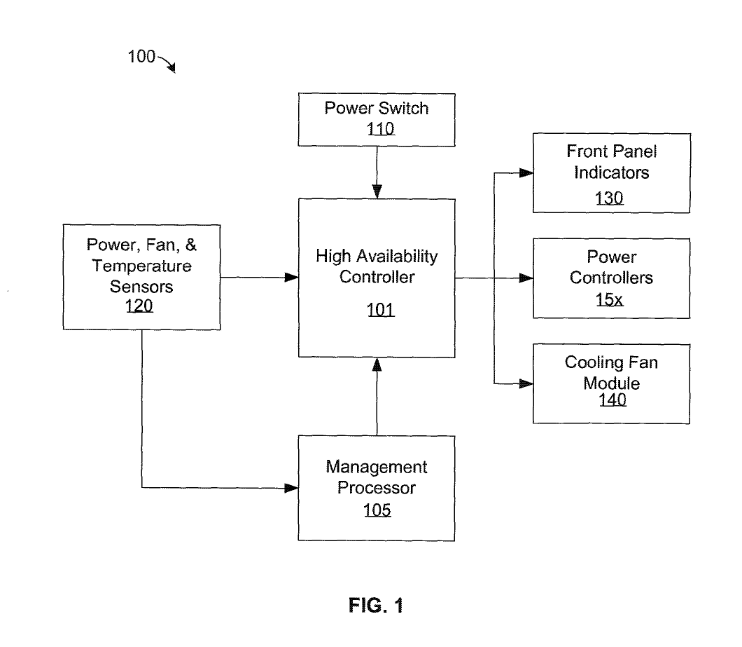

FIG. 1 is a block diagram illustrating basic components of the present system 100. As shown in FIG. 1, the high level components of system 100 comprise one or more management processors 105, a high-availability controller 101, power, fan, and system temperature sensors 120, front panel indicators 130, cooling fan controller module 140, a plurality of power controllers 150, and a power switch 110.

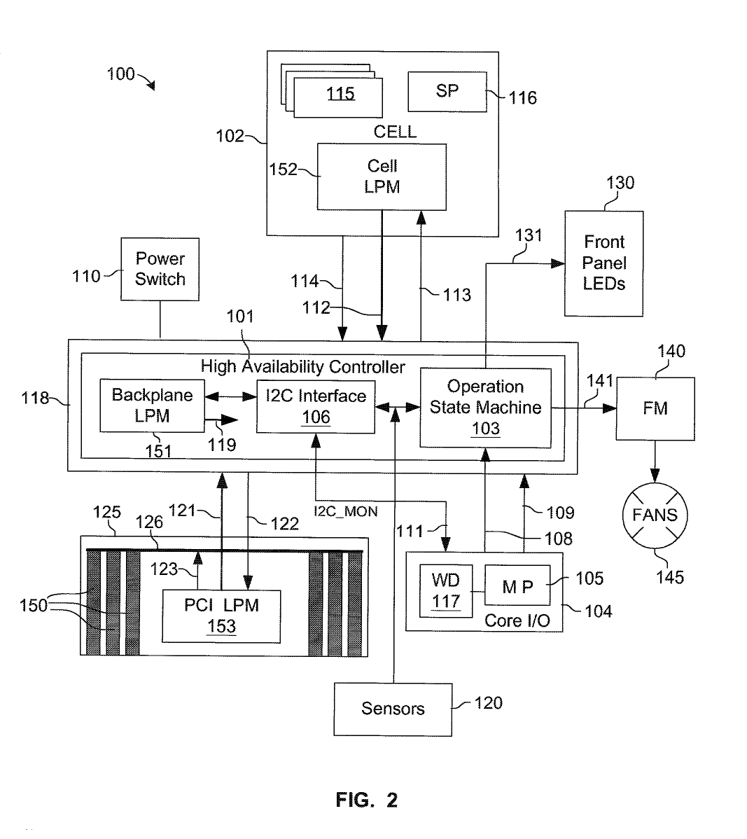

Management processor 105 monitors and controls various aspects of the system environment such as power, via power controllers 15x (local power modules 151, 152, and 153, shown in FIG. 2); temperature, via cooling fans controlled by module 140; and updating panel indicators 130. Management processor 105 manages operations associated with core I/O board 104, which includes I/O controllers for peripheral devices, bus management, and the like. High-availability controller 101 monitors the status of management processor 105, and as well as power, fan, and temperature sensors 120. In the situation wherein high-availability controller 101 detects failure of the management processor 105, it assumes control of the system 100, as described below in greater detail.

Since the high-availability controller does not perform the same sequence of operations as the code executed by the management processor, it is therefore not susceptible to failure resulting from a specific ‘bug’ that may cause the management processor to fail.

### Normal System Operation

While management processor 105 is operating properly, the following events take place. When the front panel power switch 110 is pressed, high-availability controller 101 recognizes this and notifies the management processor via an interrupt. The management processor evaluates the power requirements versus the available power and, if at least one system power supply is available and working properly, management processor 105 commands the high-availability controller to power up the system.

FIG. 2 shows components utilized in an exemplary embodiment of the present system in greater detail. During normal system operation, when front panel power switch 110 is pressed, the following components are powered up:

(1) system backplane 118;

(2) PCI (I/O card) backplane 125; and

(3) associated cell board 102.

Note that system 100 may include a plurality of PCI backplanes 125, each of which may contain a plurality of associated cell boards 102. In the present system, a cell (board) 102 comprises a plurality of processors 115 and associated hardware/firmware and memory (not shown); a local power module 152 for controlling power to the cell; and a local service processor 116 for managing information flow between processors 115 and external entities including management processor 105.

The front panel power switch 110 controls power to system 100 in both hard- and soft-switched modes. This allows the system to be powered up and down in the absence of a management processor 105. When front panel power switch 110 is pressed, if no cell board 102 is present, its PCI backplane 125 is not powered up; if a cell board is present, but no PCI backplane is present, the cell board is powered up, nevertheless. When the front panel power switch is again pressed, management processor 105 is again notified by an interrupt. Management processor 105 then notifies the appropriate system entities and the system is powered down.

A Cell_Present signal 114 is routed to the system board (and to high-availability controller 101) through pins located on the connector on the cell board 102. If the cell board is unplugged from the system board, the Cell_Present signal 114 is interrupted causing it to go inactive. High-availability controller 101 monitors the Cell_Present signal and, if a Cell Power Enable signal 113 is active to a cell board 102 whose ‘Cell Present’ signal 114 goes inactive, the power to the board is immediately disabled and stays disabled until the power is explicitly re-enabled to the cell board. A ‘Core 10 Present’ signal 109 is routed to the system board through pins located on the core I/O board connector. If the core I/O board 104 is unplugged, the Core 10 Present signal 109 is interrupted, causing it to go inactive.

Core I/O board 104 includes a watchdog timer 117 that monitors the responsiveness of management processor 105 to aid in determining whether the processor is operating properly. Management processor 105 includes a firmware task for checking the integrity of the system operating environment, thus providing an additional measure of proper operability of the management processor.

### operation without a Management Processor

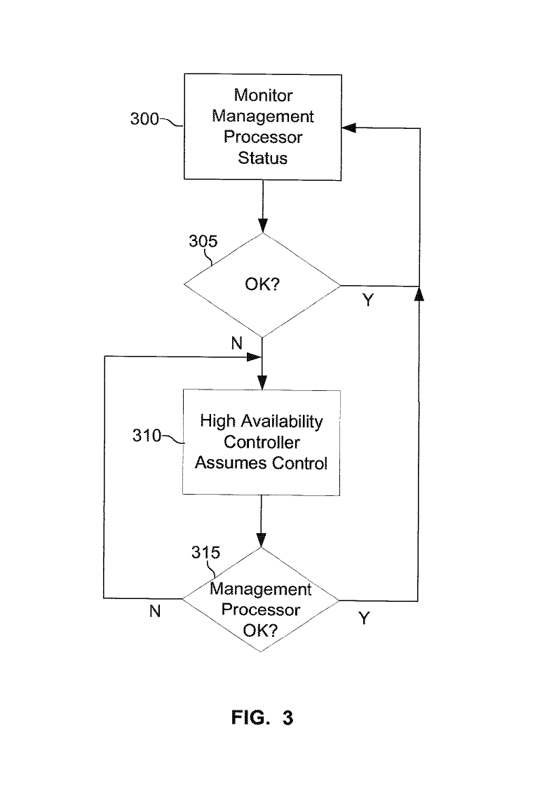

FIG. 3 is a flowchart showing an exemplary sequence of steps performed in practicing a method in accordance with the present system. Operation of the system may be better understood by viewing FIGS. 2 and 3 in conjunction with one another. In an exemplary embodiment of the present system, the operations described in FIG. 3 are performed by operation state machine 103. As shown in FIG. 3, at step 300, high-availability controller state machine 103 monitors the status of management processor 105 via ‘management processor OK’ (operational) [MP_OK] signal 108. At step 305, if MP_OK signal 108 is detected as active, management processor 105 is assumed to be operating properly, and state machine 103 continues the monitoring process, at step 300.

If state machine 103 detects MP_OK signal 108 as not active, the HAC assumes that management processor 105 is either not present in the system or not operational, and takes over management of system 100, at step 310, with the system in the same operational state as existed immediately prior to failure of management processor 105.

High-availability controller 101 enables the system and I/O fans 145 via fan controller module 140. Fan module 140 recognizes that a management processor is not operational, via an inactive SP_OK (management processor OK) signal 141 from HAC 101, and sets its fan speed to an appropriate default for unmonitored operation. Should a fan fault be detected by fan module 140, high-availability controller 101 recognizes this (via a fan fault interrupt from the fan module) and powers down the system.

The ‘Cell Present’ signal 114 is routed to high-availability controller 101 through pins located on the cell board connector. If the cell board is unplugged, the Cell Present signal is interrupted, causing it to go inactive. State machine 103 monitors the Cell Present signal 114, and, if Cell Power Enable 113 is active to a cell board whose Cell Present signal 114 goes inactive, the power to the board is immediately disabled and will stay disabled until the power is explicitly re-enabled to the board. The Core 10 Present signal 109 is routed to the HAC through pins on the core I/O board connector. If the core 10 board 104 is unplugged, the Core 10 Present signal 109 is interrupted, causing it to go inactive.

The following basic signals, provided by each powerable entity (cell(s) 102, system backplane 118, and PCI backplane 125), are used by the high-availability controller (HAC) 101:

(1) a ‘power enable’ signal (113, 122) from the 101 (HAC) to the entity LPM;

(2) a ‘device present’ signal (109, 114) to the HAC;

(3) a ‘device ready’ signal to HAC;

(4) a ‘power good’ signal to the HAC; and

(5) a ‘power fault’ signal to the HAC (except for cell LPM fault indications, which are provided to the local service processor 116 for the cell). For the sake of clarity, each of the latter three signals [(3)-( 5)] is combined into a single line in FIG. 2, as shown by lines 112, 119, and 121, for cell 102, system backplane 118, and PCI backplane 125, respectively.

At step 315, state machine 103 monitors the management processor OK signal 108 to determine whether management processor 105 is again operational. When it is determined that management processor 105 is operational, control is passed to the management processor, and high-availability controller 101 resumes its status monitoring function at step 300.

### High-Availability Controller Logic

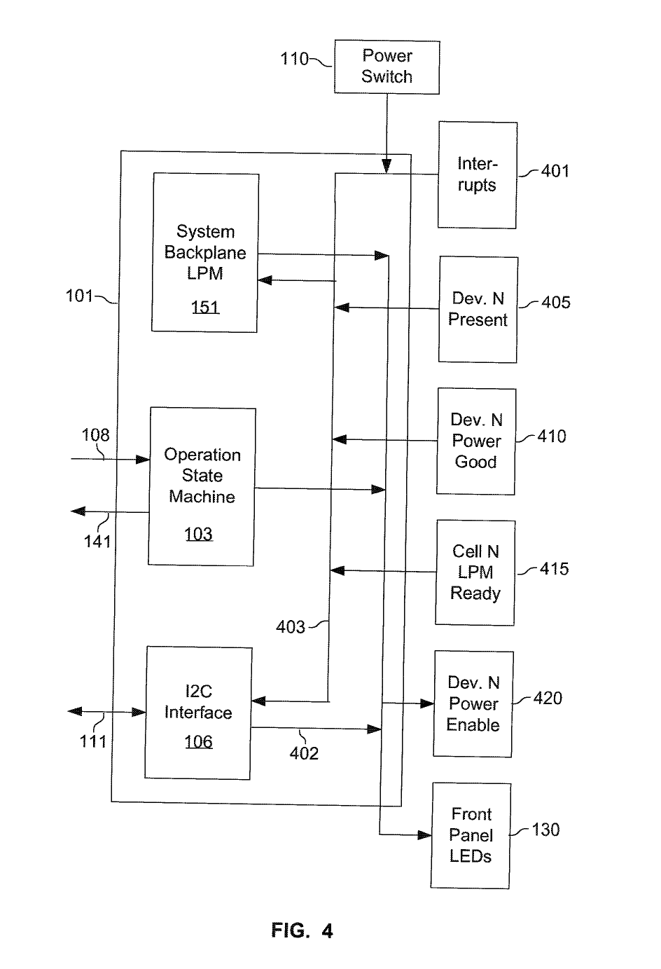

FIG. 4 is a block diagram illustrating, in greater detail, the high-availability controller of the present system. As shown in FIG. 4, high-availability controller (HAC) 101 centralizes control and status information for access by the management processor 105. In an exemplary embodiment of the present system, high-availability controller 101 is implemented as a Field Programmable Gate Array (FPGA), although other non-software coded devices could, alternatively, be employed. In any event, HAC 101 does not perform the same sequence of operations as the code executed by management processor 105.

The following sensor and control signals are either received or generated by the HAC while monitoring the operation of system 100:

(1) Front panel power switch 110 is monitored by high-availability controller 101.

(2) Fan fault signals report fan problems detected by fan module 140. Fan faults, as well as backplane power faults, are reported via interrupt bus 401, except for cell boards 102, from which fan fault signals are sent to the corresponding local service processor 116).

(3) A ‘device present’ signal 405 is sent from each major board, i.e., cell 102, PCI 125, and core IO/management processor 104 (as well as front panel & mass storage boards [not shown]) in the system indicating that the board has been properly inserted into the system.

(4) ‘Power Enable’ signals 420 are sent to each LPM 15x to control the power of each associated powerable entity. ‘Power good’ status, via signals 410 from the main power supplies and the powerable entities, confirms proper power up and power down for each entity.

(5) An ‘LPM Ready’ signal 415 comes from each board in the system. This signal indicates that the specific LPM 15x has been properly reset, all necessary resources are present, and the LPM is ready to power up the associated board.

(6) Front panel indicators (LEDs or other display devices) 130 of main power, standby power, management processor OK, and other indicators controlled by the operating system, are controllable by high-availability controller 101.

The buses indicated by lines 402 and 403 are internal to the high-availability controller FPGA, and function as ‘data out’ and ‘data in’ lines, respectively. In an exemplary embodiment of the present system, block 106 is an 12C bus interface that provides a remote interface between management processor 105 and the sensors and controls described above.

### High-availability Controller Operation State Machine

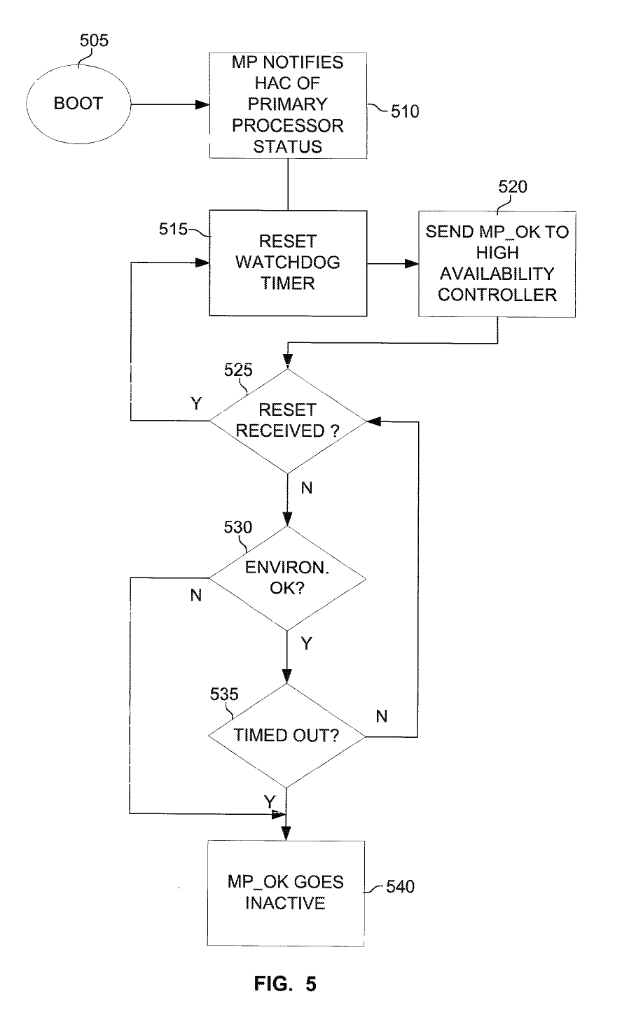

FIG. 5 is a flowchart showing an exemplary sequence of steps performed by the high-availability controller operation state machine 103. As shown in FIG. 5, after a system boot operation at step 505, wherein all management processors 105(1)-105(N) initiate execution of their respective operating systems, at step 510, the management processor 105 that has been designated as the default primary management processor 105(P) notifies high-availability controller 101 of its primary processor status. High-availability controller 101 then enables management processor 105(P) so that it controls all system functions for which the management processor is responsible, including the monitoring and control functions described above, via 12C bus 111. All management processors 105 receive inputs from power, fan, and temperature sensors 120 (via 12C bus 111), but only primary management processor 105(P) controls the related system functions.

At step 515, all management processors 105(1)-105(N) start (reset) their watchdog timers 117. In the present exemplary embodiment, each watchdog timer 117 has a user-adjustable timeout period of between approximately 6 and 10 seconds, but other timer values may be selected, as appropriate for a particular system 100. At step 520, management processor OK (MP_OK) signal 108, which is held in an active state as long as watchdog timer 117 is running, is sent to high-availability controller 101. When a given management processor 105 is functioning properly, it periodically sends a reset signal to watchdog timer 117 to cause the timer to restart the timeout period. If a particular management processor 105 malfunctions, it is likely that the processor will not reset the watchdog timer, which will then time out, causing the MP_OK signal 108 to go inactive. When high-availability controller 101 detects an inactive MP_OK signal, the controller takes over control of system 100, as described with respect to step 310 in FIG. 3, above.

At step 525, if a watchdog timer reset signal has been sent from primary management processor 105(P), then the timer is reset, at step 515. Otherwise, at step 530, management processor 105(P) checks the status of the system environment. Management processor 105 includes a firmware task that compares system power, temperature, and fan speed with predetermined values to check the integrity of the system operating environment. If the system environmental parameters are not within an acceptable range, then management processor 105(P) does not reset the watchdog timer 117, which causes MP_OK signal 108 to go inactive, at step 540. High-availability controller 101 then takes over control of system 100, as described above. If the system environmental parameters are within an acceptable range, then at step 535, if watchdog timer 117 has not timed out, management processor loops back to step 525.

While exemplary embodiments of the present invention have been shown in the drawings and described above, it will be apparent to one skilled in the art that various embodiments of the present invention are possible. For example, the specific configuration of the system as shown in FIGS. 1, 2, and 4, as well as the particular sequence of steps described above in FIGS. 3 and 5, should not be construed as limited to the specific embodiments described herein. Modification may be made to these and other specific elements of the invention without departing from its spirit and scope as expressed in the following claims.

We claim:

1. A backup management system for providing basic system functions in a computer system, comprising:
a plurality of system sensors for detecting power, temperature, and cooling fan speed in the computer system;
a management processor, coupled to said sensors;
a high-availability controller, operably coupled to said management processor and to said sensors;
a management processor status signal, generated by said management processor to indicate an operational state thereof, and coupled to said high availability controller;
wherein said sensors include:
a plurality of power controllers, each of which monitors the state of an associated power supply in the computer system, and controls power thereto; and
at least one cooling fan controller for detecting and controlling said cooling fan speed;
wherein, during normal operation of the computer system, said management processor monitors outputs from said sensors and sends control signals to said power controllers and to said fan module; and
wherein, in response to detecting that said management processor status signal is inactive, said high availability controller generates control signals in response to outputs from said sensors to control operation of said power controllers and said fan controller.

2. The backup management system of claim 1, including a non-software coded state machine that monitors said management processor status signal and causes said high availability controller to generate said control signals when said status signal is inactive;
wherein said state machine performs a different sequence of operations than the code executed by said management processor.

3. The backup management system of claim 2, wherein said state machine is a field programmable gate array.

4. The backup management system of claim 1, including at least one cell comprising a plurality of processors and a local power module for controlling power to the cell, wherein said cell is coupled to said management processor and said high availability controller;
wherein said high availability controller receives signals from said local power module including a device ready signal and a power fault signal, and
wherein, in response to an inactive said processor status signal, said high availability controller sends a power enable signal to the local power module in response to receiving said device ready signal in the absence of a power fault signal received therefrom.

5. The backup management system of claim 1, further including a power switch, for controlling bulk power to the computer system, coupled to said management processor and said high availability controller; wherein said high-availability controller is responsive to an output from the power switch to initiate powering down of each said power supply when the management processor has failed.

6. The backup management system of claim 1, wherein said management processor includes a watchdog timer that sets said management processor status signal to an inactive state when the management processor does not reset the timer within a predetermined period of time.

7. The backup management system of claim 1, including a plurality of front panel indicators coupled to, and responsive to output signals from, said management processor and said high availability controller.

8. A method for backup management of basic system functions in a computer system, the method comprising the steps of:
monitoring, via a management processor, a plurality of sensors for detecting power, temperature, and cooling fan speed in the computer system;
generating a processor status signal to indicate an operational state of said management processor;
monitoring said processor status signal; and
generating, in response to detecting that said processor status signal is inactive, backup control signals, in response to outputs from said sensors, to control operation of said controllers;
wherein said backup control signals are generated by a non-software coded state machine, operably coupled to said management processor, said sensors, and said controllers.

9. The method of claim 8, wherein said state machine performs a different sequence of operations than the code executed by said management processor.

10. The method of claim 9, wherein said state machine is a field programmable gate array.

11. The method of claim 8, wherein said sensors include at least one cooling fan controller for detecting and controlling said cooling fan speed, and a plurality of power controllers, each of which monitors the state of, and controls power to, an associated power supply in the computer system, including the step of:
sending said control signals and said backup control signals to said power controllers and to said fan module.

12. The method of claim 11, including a power switch, for controlling bulk power to the computer system, including the step of:
initiating powering down of each said power supply when the management processor has failed and the power switch is pressed.

13. The method of claim 8, including at least one cell comprising a plurality of processors and local power module for controlling power to the cell, including the step of:
monitoring signals, including a device ready signal and a power fault signal, from said local power module, and
in response to an inactive said processor status signal, sending a power enable signal to the local power module in response to receiving said device ready signal in the absence of a power fault signal received therefrom.

14. The method of claim 8, including the step of setting a watchdog timer that generates an inactive said processor status signal when the management processor does not reset the timer within a predetermined period of time.

15. The method of claim 8, wherein said backup control signals also control a plurality of front panel indicators.

16. A backup management system for providing basic system control functions in a computer system comprising:
a plurality of system sensors for detecting signals from at least two devices in the group of devices consisting of a power module for monitoring the state of an associated power supply in the computer system, a temperature sensor for monitoring temperature in the computer system, and a cooling fan speed module for detecting and controlling system cooling fan speed;
a management processor, coupled to said system sensors;
a management processor status signal, generated by said management processor to indicate an operational state thereof;
a non-software coded state machine, operably coupled to said management processor and to said system sensors, wherein said state machine performs a different sequence of operations than the code executed by said management processor;
wherein, in response to detecting that said status signal is inactive, said state machine generates control signals to said power controllers and to said fan module in response to outputs from said system sensors to control the operation thereof.

17. The backup management system of claim 16, wherein said controllers include:
a plurality of power controllers, each of which monitors the state of an associated power supply in the computer system, and controls power thereto; and
at least one cooling fan controller for detecting and controlling said cooling fan speed.

18. The backup management system of claim 16, wherein said state machine is a field programmable gate array.

19. The backup management system of claim 16, wherein said management processor includes a watchdog timer that sets said processor status signal to an inactive state when the management processor does not reset the timer within a predetermined period of time.

20. The backup management system of claim 16, including a plurality of front panel indicators coupled to, and responsive to output signals from, said management processor and said high availability controller.
